(19) United States
(12) Patent Application Publication
(10) Pub. No.: US 2026/0142762 A1
(43) Pub. Date: May 21, 2026

(54) METHOD, DEVICE AND COMPUTER STORAGE MEDIUM OF COMMUNICATION

(71) Applicant: NEC Corporation, Tokyo (JP)

(72) Inventors: Minghui XU, Beijing (CN); Gang WANG, Beijing (CN)

(73) Assignee: NEC Corporation, Tokyo (JP)

(21) Appl. No.: 19/113,513

(22) PCT Filed: Sep. 23, 2022
(86) PCT No.: PCT/CN2022/121089

§ 371 Date: Mar. 20, 2025

(51) Int. Cl. H04L 5/00; H04B 7/06; H04B 7/15

(52) U.S. Cl. CPC H04L 5/0023; H04B 7/06952; H04B 7/15; H04L 5/0053; H04L 5/0064; H04L 5/0094

(57) ABSTRACT

Embodiments of the present disclosure relate to methods, devices and computer readable media for communication. A network device determines an application time for a beam of a repeater device and a SCS associated with the application time, and determines time domain resource allocation information indicating the application time based on the determined SCS. The network device transmits, to the repeater device, the time domain resource allocation information and indication information regarding the indicating of the application time. In this way, an application time for a beam of a NCR may be efficiently indicated.

### TECHNICAL FIELD

Embodiments of the present disclosure generally relate to the field of telecommunication, and in particular, to methods, devices and computer storage media of communication for beam management of a network-controlled repeater (NCR).

### BACKGROUND

Recently, a NCR is introduced by adding side control information for beam management on a basis of a radio frequency (RF) repeater to extend coverage in a high frequency (HF) with a higher efficient method. It has been agreed that a time domain resource corresponding to an access link between a NCR and a terminal device can be determined with explicit determination based on explicitly indicated time domain resources per beam indication. However, details about indication of a time domain resource for an access beam of a NCR are still undefined and need to be developed.

### SUMMARY

In general, embodiments of the present disclosure provide methods, devices and computer storage media of communication for beam management of a NCR.

In a first aspect, there is provided a method of communication. The method comprises: determining, at a network device, an application time for a beam of a repeater device: determining a subcarrier spacing associated with the application time: determining time domain resource allocation information indicating the application time based on the determined subcarrier spacing; and transmitting, to the repeater device, the time domain resource allocation information and indication information regarding the indicating of the application time.

In a second aspect, there is provided a method of communication. The method comprises: receiving, at a repeater device and from a network device, time domain resource allocation information indicating an application time for a beam of a repeater device and indication information regarding the indicating of the application time: determining a subcarrier spacing associated with the application time; and determining the application time based on the time domain resource allocation information, the indication information and the determined subcarrier spacing.

In a third aspect, there is provided a device of communication. The device comprises a processor configured to cause the device to perform the method according to the first or second aspect of the present disclosure.

In a fourth aspect, there is provided a computer readable medium having instructions stored thereon. The instructions, when executed on at least one processor, cause the at least one processor to perform the method according to the first or second or third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication scenario in which some embodiments of the present disclosure can be implemented:

FIG. 1B illustrates an example communication model of a NCR in which some embodiments of the present disclosure can be implemented;

FIG. 2 illustrates a schematic diagram illustrating an example process of communication according to embodiments of the present disclosure:

FIG. 3A illustrates a schematic diagram illustrating an example time domain resource allocation for a beam of a NCR according to embodiments of the present disclosure:

FIG. 3B illustrates a schematic diagram illustrating an example time domain resource allocation for a beam of a NCR according to embodiments of the present disclosure:

FIG. 4A illustrates a schematic diagram illustrating an example time domain resource allocation for a beam of a NCR according to embodiments of the present disclosure:

FIG. 4B illustrates a schematic diagram illustrating an example time domain resource allocation for a beam of a NCR according to embodiments of the present disclosure:

FIG. 4C illustrates a schematic diagram illustrating an example time domain resource allocation for a beam of a NCR according to embodiments of the present disclosure:

FIG. 5A illustrates a schematic diagram illustrating an example time domain resource allocation for a beam of a NCR according to embodiments of the present disclosure;

FIG. 5B illustrates a schematic diagram illustrating an example time domain resource allocation for a beam of a NCR according to embodiments of the present disclosure:

FIG. 5C illustrates a schematic diagram illustrating an example time domain resource allocation for a beam of a NCR according to embodiments of the present disclosure;

FIG. 6A illustrates a schematic diagram illustrating an example time domain resource allocation for a beam of a NCR according to embodiments of the present disclosure:

FIG. 6B illustrates a schematic diagram illustrating an example time domain resource allocation for a beam of a NCR according to embodiments of the present disclosure:

FIG. 7 illustrates an example method of communication implemented at a network device in accordance with some embodiments of the present disclosure;

FIG. 8 illustrates an example method of communication implemented at a repeater device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure.

The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater” may be interchangeably used with “repeater device” or “network-control repeater”, and the term “beam” may be interchangeably used with “link” or “channel” or “spatial filter”. In the context of the present application, the term “side control information” may be interchangeably used with “control information” or “on-off information”. In the context of the present application, the term “synchronization signal and physical broadcast channel block (SSB) index” may be interchangeably used with “channel state information-reference signal (CSI-RS) index”.

In the context of the present application, a slot may comprise 14 symbols if a cyclic prefix (CP) length is a normal CP, and a slot may comprise 12 symbols if a CP length is an extended cyclic prefix (ECP). For convenience, embodiments of the present disclosure are described in connection with a normal CP. It is to be understood that embodiments of the present disclosure may also be applied in connection with ECP.

Currently, it is intended to study and identify which side control information below is necessary for network-controlled repeaters including assumption of maximum transmission power:
beamforming information:
timing information to align transmission/reception boundaries of a network-controlled repeater:
information on uplink (UL)-downlink (DL) time division duplexing (TDD) configuration:
on-off information for efficient interference management and improved energy efficiency:
power control information for efficient interference management (as the second priority).

As mentioned above, details about indication of a time domain resource for an access beam of a NCR need to be developed. In view of this, embodiments of the present disclosure provide a solution for indicating a time domain resource (i.e., an application time) for an access beam of a NCR. In the solution, a network device may determine an application time for a beam of a repeater device and a subcarrier spacing (SCS) associated with the application time, and determine time domain resource allocation information indicating the application time based on the determined SCS. The network device may transmit, to a NCR, the time domain resource allocation information and indication information regarding the indicating of the application time. The NCR may determine the SCS and then determine the application time based on the time domain resource allocation information, the indication information and the SCS.

In this way, a time domain resource for an access beam of a NCR may be accurately indicated with an acceptable signaling overhead.

Principles and implementations of the present disclosure will be described in detail below with reference to the figures.

### Example of Communication Network

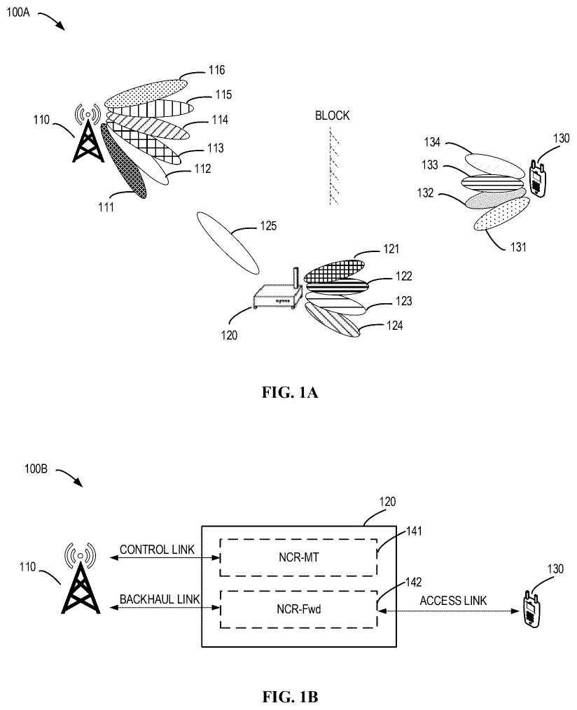

FIG. 1A illustrates a schematic diagram of an example communication network 100A in which embodiments of the present disclosure can be implemented. As shown in FIG. 1A, the communication network 100A may comprise a network device 110, a repeater device 120 and a terminal device 130. The network device 110 may serve the terminal device 130.

In some embodiments, the network device 110 may directly communicate with the terminal device 130. In this case, a link between the network device 110 and the terminal device 130 is a direct link. In some embodiments, the network device 110 may communicate with the terminal device 130 via the repeater device 120. In this case, a link between the network device 110 and the terminal device 130 via the repeater device 120 is an indirect link.

The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device 130. That is, the repeater device 120 may receive a signal from the network device 110, then amplify the received signal and forward the amplified signal to the terminal device 130. Or the repeater device 120 may receive a signal from the terminal device 130, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on UL-DL TDD configuration, on-off information for efficient interference management and improved energy efficiency, or power control information for efficient interference management.

As shown in FIG. 1A, the network device 110 may support six beams 111, 112, 113, 114, 115 and 116 for communication, the repeater device 120 may support five beams 121, 122, 123, 124, and 125 for communication, and the terminal device 130 may support four beams 131, 132, 133 and 134 for communication. These beams may serve as transmit beams or receive beams in DL or UL transmission. For convenience, assuming that the beams 111, 112, 113, 114, 115 and 116 are transmit beams of the network device 110 in DL transmission, the beams 121, 122, 123 and 124 are transmit beams of the repeater device 120 in DL transmission, the beam 125 is a receive beam of the repeater device 120 in DL transmission, and the beams 131, 132, 133 and 134 are receive beams of the terminal device 130 in DL transmission.

It is to be understood that the number of devices or beams in FIG. 1A is given for the purpose of illustration without suggesting any limitations to the present disclosure. The communication network 100A may involve any suitable number of network devices and/or repeater devices and/or terminal devices and/or beams adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates an example communication model 100B of a NCR in which some embodiments of the present disclosure can be implemented. For convenience, this will be described with reference to the example of FIG. 1A. As shown in FIG. 1B, the NCR 120 may comprise a mobile termination element (denoted as NCR-MT) 141 and a forwarding element (denoted as NCR-Fwd) 142. The NCR-MT 141 may be defined as a function entity to communicate with the network device 110 via a control link to enable information exchange (e.g., side control information). The control link may be based on a Uu interface. The side control information may be at least used for the control of the NCR-Fwd 142. The NCR-Fwd 142 may defined as a function entity to perform the amplify-and-forwarding of UL/DL RF signal between the network device 110 and the terminal device 130 via a backhaul link and an access link. The behavior of the NCR-Fwd 142 will be controlled according to the received side control information from the network device 110.

It has been agreed that a time domain resource corresponding to a beam (also referred to as an access beam) of an access link may be determined with explicit determination based on the explicitly indicated time domain resources per beam indication.

Different parameters may be indicated for semi-static or dynamic beam indication. One or multiple beams may be indicated via single beam indication.

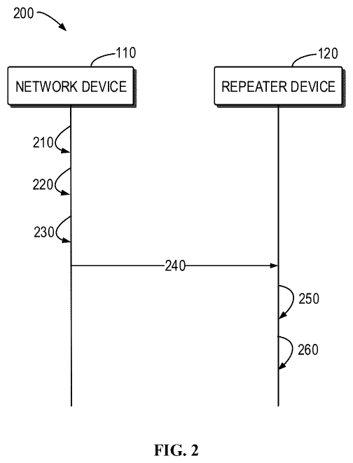

Embodiments of the present disclosure provide a solution for indicating a time domain resource (i.e., an application time) for an access beam of a NCR. The solution will be described below with reference to FIGS. 2 to 6B.

### Example Implementation of Indication of Application Time

FIG. 2 illustrates a schematic diagram illustrating an example process 200 of communication according to embodiments of the present disclosure. For the purpose of discussion, the process 200 will be described with reference to FIG. 1. The process 200 may involve the network device 110, the repeater device 120 and the terminal device 130 as illustrated in FIG. 1A. It to be noted that the process 200 may comprise more additional steps or omit some steps shown, and the present disclosure does not limit the order of the steps.

As shown in FIG. 2, the network device 110 may determine 210 an application time for a beam of the repeater device 120. In some embodiments, the network device 110 may determine respective application time for each beam of the repeater device 120, e.g., based on an application time of a beam of the terminal device 130. The present disclosure does not limit this aspect, and any other suitable factors may also be considered for determination of the application time.

The network device 110 may determine 220 a SCS associated with the application time. In some embodiments, the network device 110 may determine the SCS associated with the application time based on a SCS of the repeater device 120. In some embodiments, the network device 110 may determine the SCS associated with the application time based on a SCS of the terminal device 130. In some embodiments, the SCS of the terminal device 130 may be indicated to the repeater device 120 by the network device 110. In some embodiments, the network device 110 may determine the SCS associated with the application time based on a predetermined or preconfigured SCS or reference SCS.

Based on the determined SCS, the network device 110 may determine 230 time domain resource information so as to indicate the application time. Then the network device 110 may transmit 240, to the repeater device 120, the time domain resource allocation information and indication information regarding the indicating of the application time, e.g., in SCI.

Upon reception of the time domain resource allocation information and the indication information, the repeater device 120 may determine 250 the SCS in a similar way. Then the repeater device 120 may determine 260 the application time based on the time domain resource allocation information, the indication information and the determined SCS.

For illustration, some example embodiments will be described below in connection with Embodiments 1 to 7.

### EMBODIMENT 1

In this embodiment, the application time may be consecutive, and the indication information may indicate that the application time is associated with a set of consecutive time domain resources.

In some embodiments, the network device 110 may determine a slot offset and the number of slots associated with the set of consecutive time domain resources. The slot offset and the number of slots may be transmitted as the time domain resource allocation information. In this case, the application time is consecutive in slot level.

In some embodiments, the network device 110 may determine a slot offset, the number of slots associated with the set of consecutive time domain resources, a symbol offset in the first slot among the slots, and a symbol length in the last slot among the slots. The slot offset, the number of slots, the symbol offset and the symbol length may be transmitted as the time domain resource allocation information. In this case, the application time is consecutive in symbol level.

In the context of the present disclosure, a slot offset may be defined with respect to a slot (e.g., where SCI is located) in which the time domain resource allocation information is transmitted. In this case, the slot offset may refer to an interval between the first slot of the set of consecutive time domain resources and the slot where the SCI is located. In other words, the slot offset may refer to a difference between an index of the first slot of the set of consecutive time domain resources and an index of the slot where the SCI is located.

In some embodiments, the slot offset may be zero. In this case, the first slot of the set of consecutive time domain resources and the slot where SCI is located are the same slot. It is to be understood that the slot offset may take any other suitable values.

Alternatively, the slot offset may be defined with reference to a system frame or a subframe. In this case, the slot offset may refer to an interval between the first slot of the set of consecutive time domain resources and the first slot of the system frame or subframe. In some embodiments, the slot offset may be zero. In this case, the first slot of the set of consecutive time domain resources and the first slot of the system frame or subframe are the same slot. Of course, the slot offset may also take any other suitable values.

It is to be understood that the slot offset may also be defined in any other suitable ways and the present application does not limit this aspect.

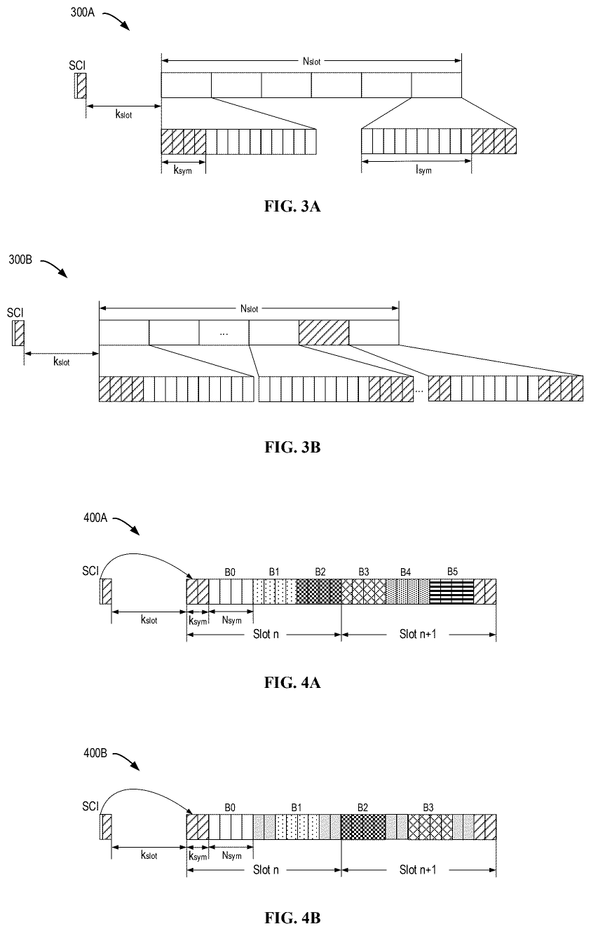

FIG. 3A illustrates a schematic diagram 300A illustrating an example time domain resource allocation for a beam of a NCR according to embodiments of the present disclosure. In this example, it is illustrated that the application time is consecutive in symbol level. As shown in FIG. 3A, kₛₗₒₜ denotes a slot offset with respect to a slot of SCI, Nₛₗₒₜ denotes the number of slots associated with the set of consecutive time domain resources, k_{sym} denotes a symbol offset in the first slot among the slots, and I_{sym} denotes a symbol length available in the last slot among the slots.

In some embodiments, by considering PDCCH of the terminal device 130 is located in front of the first slot among the slots, k_{sym} may be omitted, or a default value for k_{sym} may be set as 0. In some embodiments, if the last some symbols in the last slot are not scheduled for any other terminal devices, I_{sym} may be omitted, or the default value for I_{sym} may be set as 13 (in case of a normal CP) or 11 (in case of an extended CP).

In some embodiments, the maximum value of kₛₗₒₜ may be set to 32, and the maximum value of Nₛₗₒₜ may be set to 16. In some embodiments, the minimum value of kₛₗₒₜ may be greater than a threshold kₜₕ, kₜₕ may be determined by processing capability of the repeater device 120, which includes PDCCH decoding capability, and information exchange capability between the NCR-MT 141 and the NCR-Fwd 142, and/or beam switching capability of the NCR-Fwd 142.

In some embodiments, each indication for a set of consecutive time domain resources may be associated with one beam.

In some embodiments, the network device 110 may determine a gap between adjacent sets of consecutive time domain resources for the beam and another beam (also referred to as a further beam herein) of the repeater device 120. The gap may also be transmitted as the time domain resource allocation information. In other words, a gap between two adjacent sets of consecutive time domain resources may be indicated for other sets of consecutive time domain resources than the first set of consecutive time domain resources. In this way, multiple sets of consecutive time domain resources for multiple beams may be indicated.

### EMBODIMENT 2

In this embodiment, the indication information may indicate that the application time is associated with an indication (also referred to as an on-off indication herein) for turning on or off the repeater device 120.

In some embodiments, the network device 110 may associate, with the indication for turning on or off the repeater device 120, a valid or invalid resource in a set of consecutive time domain resources for the application time. The network device 110 may determine a slot offset and the number of slots associated with the set of consecutive time domain resources. In some embodiments, an on-off indication has a higher priority than an time domain resource indication for a beam of the NCR-Fwd 142. In other words, a set of consecutive time domain resources may be indicated to the repeater device 120 and the repeater device 120 may determine valid and invalid resources in the set of consecutive time domain resources based on the on-off indication. The determined valid resources may correspond to the application time for a beam of the repeater device 120.

FIG. 3B illustrates a schematic diagram 300B illustrating an example time domain resource allocation for a beam of a NCR according to embodiments of the present disclosure. In this example, a slot level indication is used. As shown in FIG. 3B, kₛₗₒₜ and Nₛₗₒₜ may be indicated to the repeater device 120. kₛₗₒₜ denotes a slot offset with respect to a slot of SCI or a slot offset with respect to the first slot of a system frame, Nₛₗₒₜ denotes the number of slots associated with a set of consecutive time domain resources.

In some embodiments, the maximum value of kₛₗₒₜ may be set to 32, and the maximum value of Nₛₗₒₜ may be set to 16. In some embodiments, the minimum value of kₛₗₒₜ may be greater than a threshold kₜₕ. kₜₕ may be determined by processing capability of the repeater device 120, which includes PDCCH decoding capability, and information exchange capability between the NCR-MT 141 and the NCR-Fwd 142, and/or beam switching capability of the NCR-Fwd 142.

Valid or invalid resources in the set of consecutive time domain resources may be indicated via the on-off indication. In some embodiments, one or multiple on-off indications may be applied. For example, one indication may indicate one slot. In another example, one indication may indicate multiple slots. In some embodiments, the on-off indication may be indicated by semi-static or dynamic indication. For example, the dynamic indication may comprise a symbol-level bitmap for a given slot. In another example, the dynamic indication may comprise a slot-level bitmap for several slots, and for a slot corresponding to turning on of the repeater device 120, an additional symbol-level bitmap may be used for the slot. In still another example, the semi-static indication may comprise a slot-level bitmap for multiple slots.

As shown in FIG. 3B, reference sign 310 denotes symbols or slots corresponding to turning off of the repeater device 120, and reference sign 320 denotes symbols or slots corresponding to turning on of the repeater device 120. In other words, the reference sign 310 denotes a time resource reserved or defined or allocated for no beam, and the reference sign 320 denotes a time resource applied to one beam of the repeater device 120.

In this way, the indicated consecutive time, only comprises an application time of one beam, and does not comprise an application time of another beam, then a set of consecutive time domain resources including the application time of the one beam is indicated.

### EMBODIMENT 3

In this embodiment, the indication information may indicate that the application time is associated with a beam index list for a set of beams of the repeater device 120.

In some embodiments, the network device 110 may determine a slot offset, a symbol offset within the first slot for the first beam among the set of beams, the number of symbols for a beam (e.g., each beam) in the set of beams, and the beam index list. In some embodiments, the number of symbols for each beam may be a default value, e.g., 4 or the number of symbols of a half-slot. In this way, regular timer domain resources for multiple beams may be indicated in a symbol-group level.

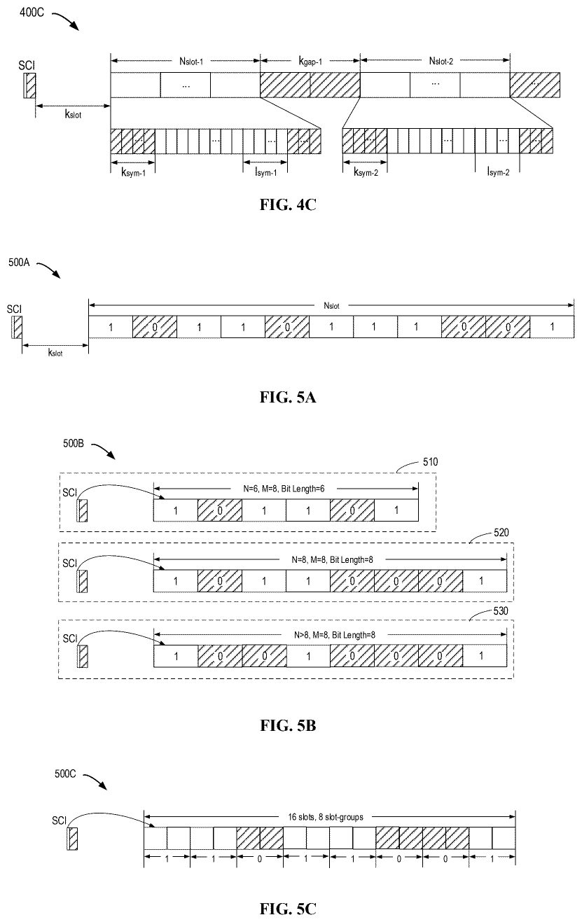

FIG. 4A illustrates a schematic diagram 400A illustrating an example time domain resource allocation for a beam of a NCR according to embodiments of the present disclosure. As shown in FIG. 4A, kₛₗₒₜ, k_{sym}, N_{sym} and a beam index list {B0, B1, B2, B3, B4, B5} may be indicated to the repeater device 120. kₛₗₒₜ denotes a slot offset with respect to a slot of SCI, or a slot offset with respect to the first slot of a system frame, k_{sym} denotes a symbol offset within the first slot for the first beam among the set of beams, and N_{sym} denotes the number of application symbols for each beam. In this example, one beam corresponds to several symbols. Beam switching time between two adjacent beams may be comprised in a length of symbols or slots for each beam.

In some embodiments, the network device 110 may determine a slot offset, a symbol offset within the first slot for the first beam among the set of beams, the number of symbols for a beam (e.g., each beam) in the set of beams, the number of guard symbols between adjacent beams among the set of beams, and the beam index list. In some embodiments, the number of symbols for each beam may be a default value, e.g., 4 or number of symbols of a half-slot. In this way, regular timer domain resources for multiple beams may also be indicated.

FIG. 4B illustrates a schematic diagram 400B illustrating an example time domain resource allocation for a beam of a NCR according to embodiments of the present disclosure. As shown in FIG. 4B, kₛₗₒₜ, k_{sym} N_{sym}, k_{gap} and a beam index list {B0, B1, B2, B3} may be indicated to the repeater device 120. kₛₗₒₜ denotes a slot offset with respect to a slot of SCI or a slot offset with respect to the first slot of a system frame, k_{sym} denotes a symbol offset within the first slot for the first beam among the set of beams, N_{sym} denotes the number of symbols for each beam, and k_{gap} denotes the number of guard symbols. In this example, one beam corresponds to several symbols. Beam switching time is considered as guard symbols explicitly.

In some embodiments, the network device 110 may determine a slot offset, the number of slots for a beam in the set of beams, and the beam index list. In these embodiments, one beam may correspond to one or multiple slots. Beam switching time may be comprised in a length of slots for each beam. In this way, regular timer domain resources for multiple beams may be indicated in a slot level or a slot-group level.

In some embodiments, the network device 110 may determine a slot offset, the number of slots for a beam in the set of beams, the number of guard slots between adjacent beams among the set of beams, and the beam index list. In these embodiments, one beam may correspond to one or multiple slots. Beam switching time is considered as guard slots explicitly. In this way, regular timer domain resources for multiple beams may also be indicated in a slot level.

In some scenarios, the application time for a beam determined according to the regular method may be across a slot boundary, for example, M symbols and N symbols are located at two consecutive slots. In this case, the number of application symbols for the beam will be re-determined. In some embodiments, the number of application symbols may be re-counted from the first symbol of the next slot. In some embodiments, the number of application time for the beam may be clipped to M symbols by the slot boundary:

In some alternative embodiments, the application symbols may be determined according to the values of M and/or M+N. For example, if M<N-threshold, the application time may be re-counted from the first symbol of the next slot. If M≥N-threshold, the application time may be clipped to M symbols by the slot boundary. N-threshold may be equal to (M+N)/2, or M+N−2.

### EMBODIMENT 4

In this embodiment, the indication information may indicate that the application time is associated with multiple sets of consecutive time domain resources. In other words, the multiple sets of consecutive time domain resources may be indicated for one beam.

In some embodiments, the network device 110 may determine a slot offset, the number of slots in one of the multiple sets of consecutive time domain resources, and a gap between adjacent ones of the multiple sets of consecutive time domain resources. In this way, multiple sets of consecutive time domain resources may be indicated in a slot level.

In some embodiments, the network device 110 may determine a slot offset for the first one of the multiple sets of consecutive time domain resources, the number of slots in one of the multiple sets of consecutive time domain resources, a symbol offset in the first slot for one of the multiple sets of consecutive time domain resources, a symbol length in the last slot for one of the multiple sets of consecutive time domain resources, and a gap between adjacent ones of the multiple sets of consecutive time domain resources. In this way, multiple sets of consecutive time domain resources may be indicated in a symbol level.

In these embodiments, the gap may refer to an interval between the last slot or symbol of a previous set of consecutive time domain resources and the first slot or symbol of a current set of consecutive time domain resources. The gap may be in unit of slots or symbols.

FIG. 4C illustrates a schematic diagram 400C illustrating an example time domain resource allocation for a beam of a NCR according to embodiments of the present disclosure. In this example, multiple sets of consecutive time domain resources are indicated in a symbol-group level. As shown in FIG. 4C, k_{sym-i}, I_{sym-i} and Nₛₗₒₜ₋ᵢ may be indicated for the i-th set of consecutive time domain resources, where i=1, 2, . . . k_{sym-i} denotes a symbol offset in the first slot for the i-th set of consecutive time domain resources, I_{sym-i} denotes a symbol length in the last slot for the i-th set of consecutive time domain resources, and Nₛₗₒₜ₋ᵢ denotes the number of slots in the i-th set of consecutive time domain resources. In addition, kₛₗₒₜ may be indicated for the first set of consecutive time domain resources, and k_{gap-i} may be indicated for the (i+1)-th set of consecutive time domain resources. kₛₗₒₜ denotes a slot offset with respect to a slot of SCI or a slot offset with respect to the first slot of a system frame, and k_{gap-i} denotes a gap between the i-th set of consecutive time domain resources and the (i+1)-th set of consecutive time domain resources.

It is to be understood that the i-th set of consecutive time domain resources (i=1, 2, . . . ) is merely for illustration, and is not intended for limitation. The (i+1)-th set of consecutive time domain resources (i=0, 1, 2, . . . ) may also be used.

In this way, non-consecutive time domain resources may be indicated for a beam of a NCR.

### EMBODIMENT 5

In this embodiment, the indication information may indicate that the application time is associated with a bitmap. In this embodiment, the bitmap may be in a slot level.

In some embodiments, the network device 110 may determine a slot offset, and a bitmap of the application time in time domain resources based on the slot offset.

In some embodiments, the bitmap may comprise a first bitmap in a slot level and a second bitmap in a symbol level for a slot, the slot corresponding to a predetermined bit value in the first bitmap. For example, for a slot corresponding to “1” in the first bitmap, an additional bitmap (i.e., the second bitmap) in symbol level may be used to further indicate the symbol resources within the slot.

FIG. 5A illustrates a schematic diagram 500A illustrating an example time domain resource allocation for a beam of a NCR according to embodiments of the present disclosure. In this example, multiple non-consecutive time domain resources are indicated with a bitmap in a slot level. As shown in FIG. 5A, kₛₗₒₜ and a bitmap {101101110 . . . 1} may be indicated. kₛₗₒₜ denotes a slot offset with respect to a slot of SCI, or a slot offset with respect to the first slot of a system frame.

In some embodiments, a bit length of the bitmap may be fixed. For example, the bit length may be 32. Of course, any other suitable values are also feasible.

In some embodiments, a bit length of the bitmap may be pre-configured. For example, bit lengths may be pre-configured or configured simultaneously with the time domain resource indication, e.g., 4, 8, 16, and 32. For example, bits 00 may be configured to indicate 4, bits 01 may be configured to indicate 8, bits 10 may be configured to indicate 16, and bits 11 may be configured to indicate 32. In some embodiments, the bit lengths may be associated with the determined SCS, for example, higher SCS, larger bit length.

In some embodiments, a bit length of the bitmap may be dynamically determined. In some embodiments, a bit length of the bitmap may be determined based on a predefined maximum bit length and a bit length when the number of predetermined bit values reaches a predetermined number (for convenience, also referred to as a first predetermined number herein). In some embodiments, the first predetermined number and the predefined maximum bit length may be associated with the determined SCS. For example, a bit length of a bitmap may be dynamically determined based on equation (1) below:

$$L = min \{ N , M \} \qquad ( 1 )$$

where L denotes a bit length of a bitmap, N denotes a bit length when the number of predetermined bit values (e.g., “1”) reaches a predetermined number S, and M denotes a predefined or pre-configured maximum bit length.

In some embodiments, S may be associated with M. In some embodiments, S and M may be associated with the determined SCS. For example, a higher SCS may correspond to larger S and M. For illustration, some example embodiments will be described with reference to FIG. 5B.

FIG. 5B illustrates a schematic diagram 500B illustrating an example time domain resource allocation for a beam of a NCR according to embodiments of the present disclosure. In this example, S is equal to 4. In the example shown by reference sign 510, N=6 and M=8. In this case, the bit length is 6. In the example shown by reference sign 520, N=8 and M=8. In this case, the bit length is 8. In the example shown by reference sign 530, N>8 and M=8. In this case, the bit length is 8.

In this way, a bitmap in slot level may be used to indicate non-consecutive time domain resources in slot-level for one beam.

### EMBODIMENT 6

In this embodiment, the indication information may indicate that the application time is associated with a bitmap. In this embodiment, the bitmap may be in a slot-group level. In other words, a bit in the bitmap may be associated with a slot group. In this way, a bitmap in slot-group level may be used to indicate non-consecutive time domain resources for one beam.

FIG. 5C illustrates a schematic diagram 500C illustrating an example time domain resource allocation for a beam of a NCR according to embodiments of the present disclosure. In this example, the number of slots associated with a set of consecutive time domain resources is 16. The number of slot groups is 8 and the number of slots in a slot group is 2. Then a bit in a bitmap corresponds to 2 slots. As shown in FIG. 5C, a bitmap {11011001} is indicated.

In some embodiments, the number of slots in a slot group may be fixed, e.g., 2 or 4 or 8 or any other suitable numbers. In some embodiments, the number of slots in a slot group may be pre-configured or configured, e.g., 1, 2, 4, 8 or any other suitable numbers.

In some embodiments, the number of slots in a slot group may be determined based on a predefined rule. In some embodiments, the number of slots in a slot group may be associated with the determined SCS. For example, a higher SCS may correspond to more slots in a slot group. In some embodiments, the number of slots in a slot group may be associated with a predefined maximum number of slots in the set of consecutive slots indicated by the bitmap.

In some embodiments, for a slot group corresponds to a predetermined bit value in the bitmap, the network device 110 may determine a further bitmap in a slot level to further indicate slot resources within the slot group.

In some embodiments, the number of slot groups associated with the bitmap may be fixed. In some embodiments, the number of slot groups associated with the bitmap may be preconfigured or configured.

In some embodiments, the number of slot groups associated with the bitmap may be dynamically determined. In some embodiments, the number of slot groups associated with the bitmap may be determined based on a predefined maximum number of slots and the number of slots when the number of slots corresponding to a predetermined bit value reaches a predetermined number (for convenience, also referred to as a second predetermined number herein). For example, the number of slot groups associated with a bitmap may be dynamically determined based on equations (2) to (3) below.

$${L}^{′} = min \{ {N}^{′} , M 1 \} \qquad ( 2 )$$

$${N}^{′} = ⌈ N 1 / M 2 ⌉ \qquad ( 3 )$$

where L′ denotes the number of slot groups associated with the bitmap, NI denotes the number of slots corresponding to a predetermined bit value (e.g., “1”) reaches a predetermined number S′, M1 denotes a predefined or pre-configured maximum number of slot groups, and M2 denotes a predefined or pre-configured maximum number of slots. ‘┌.┐’ denotes ceil operation.

In this way, a bitmap in slot-group level may be used to indicate multiple sets of consecutive time domain resources for one beam.

### EMBODIMENT 7

In this embodiment, the indication information may indicate that the application time is associated with priorities of resources.

In some embodiments, the network device 110 may determine a set of consecutive time domain resources comprising a first resource corresponding to the application time and a set of second resources, and indicate, on the set of consecutive time domain resources, the application time based on priorities of the first resource and the set of second resources. In other words, if the first resource and the set of second resources form the set of consecutive time domain resources, the network device 110 may determine that the application time is indicated by indicating the set of consecutive time domain resources. A priority of the second resource may be higher than or lower than a priority of the first resource.

Then the network device 110 may determine a slot offset and the number of slots associated with the set of consecutive time domain resources, and transmit the slot offset and the number of slots as the time domain resource allocation information.

The repeater device 120 may determine the set of consecutive time domain resources based on the slot offset and the number of slots. If a priority of a second resource in the set of second resources is higher than a priority of the first resource, the repeater device 120 may determine that time corresponding to the second resource does not belong to the application time. If a priority of the second resource is lower than a priority of the first resource, the repeater device 120 may determine that the time corresponding to the second resource belong to the application time. In this way, an application time is determined based on the priorities of resources.

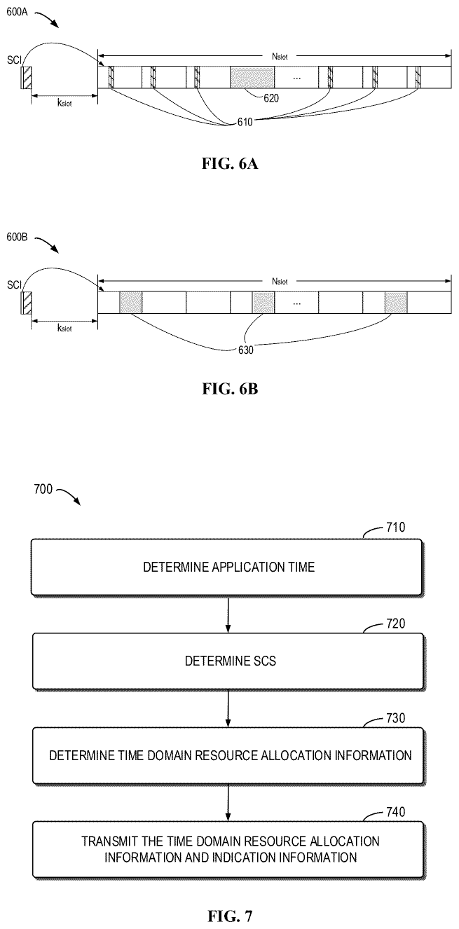

In some embodiments, the set of second resources may comprise at least one of the following: a semi-static resource: an invalid resource: a reserved resource: a resource for an uplink control channel transmission (e.g., PUCCH) of the repeater device 120; or a resource for an uplink data channel transmission (e.g., PUSCH) of the repeater device 120. For illustration, some example embodiments will be described with reference to FIGS. 6A and 6B.

FIG. 6A illustrates a schematic diagram 600A illustrating an example time domain resource allocation for a beam of a NCR according to embodiments of the present disclosure. In this example, a semi-static resource and a dynamic resource for application time of a beam are indicated in combination as a consecutive time resource.

In some embodiments, the semi-static resource may comprise a resource for a usage other than the application time indication, an invalid resource or a reserved resource. In some embodiments, the semi-static resource may comprise a beam training resource for the terminal device 130 or a ZP CSI-RS resource for the terminal device 130. In some embodiments, the semi-static resource may comprise an UL resource.

As shown in FIG. 6A, kₛₗₒₜ and Nₛₗₒₜ may be indicated to the repeater device 120. kₛₗₒₜ denotes a slot offset with respect to a slot of SCI or a slot offset with respect to the first slot of a system frame, Nₛₗₒₜ denotes the number of slots associated with a set of consecutive time domain resources. In this example, for the DL transmission, the set of consecutive time domain resources comprises beam training and ZP CSI-RS resources 610 for the terminal device 130 and UL resources 620 as one kind of invalid resource.

In some embodiments, priorities of resources may be predefined. For example, a priority of an invalid resource>a priority of a beam training and ZP CSI-RS resource>a priority of a dynamical resource of a set of consecutive time domain resource indicated for determining application time>a priority of a reserved resource. It is to be noted that these types and priority levels of resources are merely examples. More or less types are also feasible. Higher or lower priorities are also feasible. More or less priority levels are also feasible.

If a priority of a semi-static resource is higher than a priority of an indicated time resource of a set of consecutive resource for determining application time of a beam, the repeater device 120 may determine that time corresponding to the semi-static resource does not belong to the application time of the beam. If a priority of a semi-static resource is lower than a priority of an indicated time resource of a set of consecutive resource for determining application time of a beam, the repeater device 120 may determine that time corresponding to the semi-static resource belongs to the application time of the beam. In the example of FIG. 6A, as a priority of a beam training and ZP CSI-RS resource is higher than a priority of a dynamical resource of a set of consecutive resource, the beam training and ZP CSI-RS resources 610 will be determined as invalid for the application time of the beam. As a priority of an invalid resource is higher than a priority of a dynamical resource of a set of consecutive resource, and UL resource is unavailable for the DL transmission, the UL resources 620 will also be determined as invalid for the application time of the beam. Other resources indicated by the dynamical resource will be determined as the application time of the beam.

FIG. 6B illustrates a schematic diagram 600B illustrating an example time domain resource allocation for a beam of a NCR according to embodiments of the present disclosure. In this example, scheduling resources for the NCR-MT 141 and the NCR-Fwd 142 are indicated in combination.

In some embodiments, the scheduling resources for the NCR-MT 141 may comprise a resource on PUSCH, a resource on PUCCH or any other similar resources.

As shown in FIG. 6B, kₛₗₒₜ and Nₛₗₒₜ may be indicated to the repeater device 120. kₛₗₒₜ denotes a slot offset with respect to a slot of SCI or a slot offset with respect to the first slot of a system frame, Nₛₗₒₜ denotes the number of slots associated with a set of consecutive time domain resources. In this example, the set of consecutive time domain resources comprises PUCCH resources 630 for the NCR-MT 141.

In some embodiments, priorities of resources may be predefined. For example, a priority of a resource on PUCCH of the NCR-MT 141>a priority of a resource on PUSCH of the NCR-MT 141 for reporting or feedback>a priority of a consecutive resource indicated for determining application time of a beam of the NCR-Fwd 142>a priority of a resource on PUSCH of the NCR-MT 141 for data transmission. It is to be noted that these types and priority levels of resources are merely examples. More or less types are also feasible. Higher or lower priorities are also feasible. More or less priority levels are also feasible.

If a priority of a NCR-MT resource is higher than a priority of a consecutive resource indicated for determining application time of a beam, the repeater device 120 may determine that time corresponding to the NCR-MT resource does not belong to the application time of the beam. If a priority of a NCR-MT resource is lower than a priority of a consecutive resource indicated for determining application time of a beam, the repeater device 120 may determine that time corresponding to the NCR-MT resource belongs to the application time of the beam. In the example of FIG. 6B, as a priority of a resource on PUCCH of the NCR-MT 141 is higher than a priority of a consecutive resource indicated for determining application time of a beam of the NCR-Fwd 142, the resources 630 will be determined as invalid for the application time of the beam. Other consecutive resources indicated for determining application time of a beam will be determined as the application time of the beam.

In this way, an application time for a beam of a NCR may be accurately indicated with a further reduced signaling overhead.

It is to be understood that any of solutions described in Embodiments 1 to 7 may be used separately or in any suitable combination.

### Example Implementation of Methods

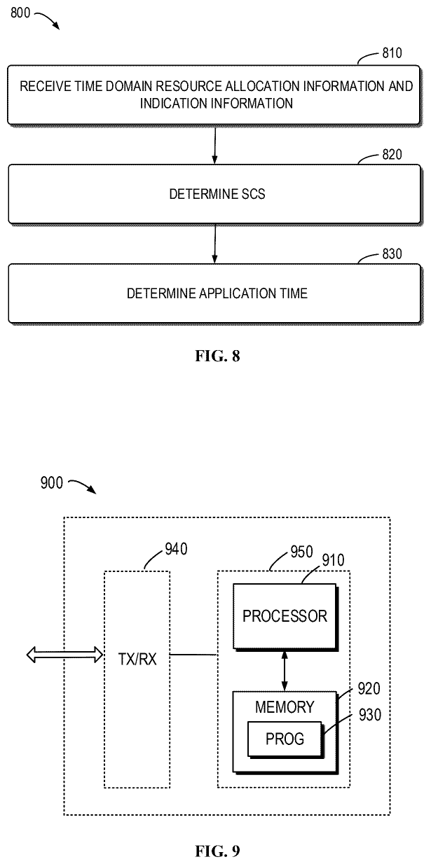

Accordingly, embodiments of the present disclosure provide methods of communication implemented at a network device, a repeater device and a terminal device. These methods will be described below with reference to FIGS. 7 to 8.

FIG. 7 illustrates an example method 700 of communication implemented at a network device in accordance with some embodiments of the present disclosure. For example, the method 700 may be performed at the network device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the network device 110 determines an application time for a beam of the repeater device 120.

At block 720, the network device 110 determines a subcarrier spacing associated with the application time. In some embodiments, the network device 110 may determine the subcarrier spacing associated with the application time based on a subcarrier spacing of the repeater device 120. In some embodiments, the network device 110 may determine the subcarrier spacing associated with the application time based on a subcarrier spacing of the terminal device 130. In some embodiments, the subcarrier spacing of the terminal device 130 may be indicated to the repeater device 120 by the network device 110. In some embodiments, the network device 110 may determine the subcarrier spacing associated with the application time based on a predetermined or preconfigured subcarrier spacing or reference subcarrier spacing.

At block 730, the network device 110 determines time domain resource allocation information indicating the application time based on the determined subcarrier spacing.

In some embodiments, the indication information indicates that the application time is associated with a set of consecutive time domain resources. In these embodiments, the network device 110 may determine a slot offset and the number of slots associated with the set of consecutive time domain resources. In some alternative embodiments, the network device 110 may determine a slot offset, the number of slots associated with the set of consecutive time domain resources, a symbol offset in the first slot among the slots, and a symbol length in the last slot among the slots. In some embodiments, the network device 110 may further determines a gap between adjacent time domain resources for the beam and a further beam of the repeater device 120.

In some embodiments, the indication information indicates that the application time is associated with an indication for turning on or off the repeater device. In these embodiments, the network device 110 may associate, with the indication for turning on or off the repeater device 120, a valid or invalid resource in a set of consecutive time domain resources, and determine a slot offset and the number of slots associated with the set of consecutive time domain resources.

In some embodiments, the indication information indicates that the application time is associated with a beam index list for a set of beams. In these embodiments, the network device 110 may determine a slot offset, a symbol offset within the first slot for the first beam among the set of beams, the number of symbols for a beam in the set of beams, and the beam index list. In some alternative embodiments, the network device 110 may determine a slot offset, a symbol offset within the first slot for the first beam among the set of beams, the number of symbols for a beam in the set of beams, the number of guard symbols between adjacent beams among the set of beams, and the beam index list. In some alternative embodiments, the network device 110 may determine a slot offset, the number of slots for a beam in the set of beams, and the beam index list. In some alternative embodiments, the network device 110 may determine a slot offset, the number of slots for a beam in the set of beams, the number of guard slots between adjacent beams among the set of beams, and the beam index list.

In some embodiments, the indication information indicates that the application time is associated with multiple sets of consecutive time domain resources. In these embodiments, the network device 110 may determine a slot offset, the number of slots in one of the multiple sets of consecutive time domain resources, and a gap between adjacent ones of the multiple sets of consecutive time domain resources. In some alternative embodiments, the network device 110 may determine a slot offset for the first one of the multiple sets of consecutive time domain resources, the number of slots in one of the multiple sets of consecutive time domain resources, a symbol offset in the first slot for one of the multiple sets of consecutive time domain resources, a symbol length in the last slot for one of the multiple sets of consecutive time domain resources, and a gap between adjacent ones of the multiple sets of consecutive time domain resources.

In some embodiments, the indication information indicates that the application time is associated with a bitmap. In these embodiments, the network device 110 may determine a slot offset, and a bitmap of the application time in time domain resources based on the slot offset. In some embodiments, the bitmap comprises a first bitmap in a slot level and a second bitmap in a symbol level for a slot, the slot corresponding to a predetermined bit value in the first bitmap.

In some embodiments, a bit length of the bitmap is fixed. In some embodiments, a bit length of the bitmap is configured. In some embodiments, a bit length of the bitmap is associated with the determined sub-carrier spacing. In some embodiments, a bit length of the bitmap is determined based on a predefined maximum bit length and a bit length when the number of predetermined bit values reaches a first predetermined number. In some embodiments, the first predetermined number and the predefined maximum bit length are associated with the determined sub-carrier spacing.

In some embodiments, a bit in the bitmap is associated with a slot group. In some embodiments, the number of slots in the slot group is fixed. In some embodiments, the number of slots in the slot group is configured. In some embodiments, the number of slots in the slot group is associated with the determined sub-carrier spacing or a predefined maximum number of slots. In some embodiments where the slot group corresponds to a predetermined bit value in the bitmap, the network device 110 may also determine a further bitmap in a slot level for the slot group.

In some embodiments, the number of slot groups associated with the bitmap is fixed. In some embodiments, the number of slot groups associated with the bitmap is configured. In some embodiments, the number of slot groups associated with the bitmap is determined based on a predefined maximum number of slots and the number of slots when the number of slots corresponding to a predetermined bit value reaches a second predetermined number.

In some embodiments, the indication information indicates that the application time is associated with priorities of resources. In these embodiments, the network device 110 may indicate, on a set of consecutive time domain resources comprising a first resource corresponding to the application time and a set of second resources, the application time based on priorities of the first resource and the set of second resources. The network device 110 may determine a slot offset and the number of slots associated with the set of consecutive time domain resources. In some embodiments, the set of second resources comprises at least one of the following: a semi-static resource: an invalid resource: a reserved resource: a resource for an uplink control channel transmission of the repeater device 120; or a resource for an uplink data channel transmission of the repeater device 120.

In these embodiments, the slot offset may be greater than a threshold, the threshold being associated with processing capability of the repeater device 120.

At block 740, the network device 110 transmits, to the repeater device 120, the time domain resource allocation information and indication information regarding the indicating of the application time.

With the method 700, a network may efficiently indicate an application time of a beam of a NCR.

FIG. 8 illustrates an example method 800 of communication implemented at a repeater device in accordance with some embodiments of the present disclosure. For example, the method 800 may be performed at the repeater device 120 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the repeater device 120 receives, from the network device 110, time domain resource allocation information indicating an application time for a beam of a repeater device and indication information regarding the indicating of the application time.

At block 820, the repeater device 120 determines a subcarrier spacing associated with the application time. In some embodiments, the repeater device 120 may determine the subcarrier spacing associated with the application time based on a subcarrier spacing of the repeater device 120. In some embodiments, the repeater device 120 may determine the subcarrier spacing associated with the application time based on a subcarrier spacing of the terminal device 130. In some embodiments, the repeater device 120 may receive, from the network device 110, the subcarrier spacing of the terminal device 130. In some embodiments, the repeater device 120 may determine the subcarrier spacing associated with the application time based on a predetermined or preconfigured subcarrier spacing or reference subcarrier spacing.

At block 830, the repeater device 120 determines the application time based on the time domain resource allocation information, the indication information and the determined subcarrier spacing.

In some embodiments, the indication information indicates that the application time is associated with a set of consecutive time domain resources. In these embodiments, the repeater device 120 may determine, from the time domain resource allocation information, a slot offset and the number of slots associated with the set of consecutive time domain resources. In some alternative embodiments, the repeater device 120 may determine, from the time domain resource allocation information, a slot offset, the number of slots associated with the set of consecutive time domain resources, a symbol offset in the first slot among the slots, and a symbol length in the last slot among the slots. In some embodiments, the repeater device 120 may further determine, from the time domain resource allocation information, a gap between adjacent time domain resources for the beam and a further beam of the repeater device.

In some embodiments, the indication information indicates that the application time is associated with an indication for turning on or off the repeater device. In these embodiments, the repeater device 120 may determine, from the time domain resource allocation information, a slot offset and the number of slots associated with a set of consecutive time domain resources; and determine, based on the indication for turning on or off the repeater device, a valid or invalid resource in the set of consecutive time domain resources.

In some embodiments, the indication information indicates that the application time is associated with a beam index list for a set of beams. In these embodiments, the repeater device 120 may determine, from the time domain resource allocation information, a slot offset, a symbol offset within the first slot for the first beam among the set of beams, the number of symbols for a beam in the set of beams, and the beam index list. In some alternative embodiments, the repeater device 120 may determine, from the time domain resource allocation information, a slot offset, a symbol offset within the first slot for the first beam among the set of beams, the number of symbols for a beam in the set of beams, the number of guard symbols between adjacent beams among the set of beams, and the beam index list. In some alternative embodiments, the repeater device 120 may determine, from the time domain resource allocation information, a slot offset, the number of slots for a beam in the set of beams, and the beam index list. In some alternative embodiments, the repeater device 120 may determine, from the time domain resource allocation information, a slot offset, the number of slots for a beam in the set of beams, the number of guard slots between adjacent beams among the set of beams, and the beam index list.

In some embodiments, the indication information indicates that the application time is associated with multiple sets of consecutive time domain resources. In these embodiments, the repeater device 120 may determine, from the time domain resource allocation information, a slot offset, the number of slots in one of the multiple sets of consecutive time domain resources, and a gap between adjacent ones of the multiple sets of consecutive time domain resources. In some alternative embodiments, the repeater device 120 may determine, from the time domain resource allocation information, a slot offset for the first one of the multiple sets of consecutive time domain resources, the number of slots in one of the multiple sets of consecutive time domain resources, a symbol offset in the first slot for one of the multiple sets of consecutive time domain resources, a symbol length in the last slot for one of the multiple sets of consecutive time domain resources, and a gap between adjacent ones of the multiple sets of consecutive time domain resources.

In some embodiments, the indication information indicates that the application time is associated with a bitmap. In these embodiments, the repeater device 120 may determine, from the time domain resource allocation information, a slot offset, and a bitmap of the application time in time domain resources based on the slot offset.

In some embodiments, the bitmap comprises a first bitmap in a slot level and a second bitmap in a symbol level for a slot, the slot corresponding to a predetermined bit value in the first bitmap.

In some embodiments, a bit length of the bitmap is fixed. In some embodiments, a bit length of the bitmap is configured. In some embodiments, a bit length of the bitmap is associated with the determined sub-carrier spacing.

In some embodiments, a bit length of the bitmap is determined based on a predefined maximum bit length and a bit length when the number of predetermined bit values reaches a first predetermined number. In some embodiments, the first predetermined number and the predefined maximum bit length are associated with the determined sub-carrier spacing.

In some embodiments, a bit in the bitmap is associated with a slot group. In some embodiments, the number of slots in the slot group is fixed. In some embodiments, the number of slots in the slot group is configured. In some embodiments, the number of slots in the slot group is associated with the determined sub-carrier spacing or a predefined maximum number of slots.

In some embodiments, the slot group corresponds to a predetermined bit value in the bitmap. In these embodiments, the repeater device 120 may further determine, from the time domain resource allocation information, a further bitmap in a slot level for the slot group.

In some embodiments, the number of slot groups associated with the bitmap is fixed. In some embodiments, the number of slot groups associated with the bitmap is configured. In some embodiments, the number of slot groups associated with the bitmap is determined based on a predefined maximum number of slots and the number of slots when the number of slots corresponding to a predetermined bit value reaches a second predetermined number.

In some embodiments, the indication information indicates that the application time is associated with priorities of resources. In these embodiments, the repeater device 120 may determine, from the time domain resource allocation information, a slot offset and the number of slots associated with a set of consecutive time domain resources, and determine, based on priorities of a first resource corresponding to the application time and a set of second resources, the application time from the set of consecutive time domain resources.

In some embodiments, the set of second resources comprises at least one of the following: a semi-static resource: an invalid resource: a reserved resource: a resource for an uplink control channel transmission of the repeater device 120; or a resource for an uplink data channel transmission of the repeater device 120.

In some embodiments, if a priority of a second resource in the set of second resources is higher than a priority of the first resource, the repeater device 120 may determine that time corresponding to the second resource does not belong to the application time. If a priority of the second resource is lower than a priority of the first resource, the repeater device 120 may determine that the time corresponding to the second resource belong to the application time.

In these embodiments, the slot offset may be greater than a threshold, the threshold being associated with processing capability of the repeater device 120.

With the method 800, a NCR may efficiently determine an application time for a beam of the NCR.

### Example Implementation of Device and Apparatus

FIG. 9 is a simplified block diagram of a device 900 that is suitable for implementing embodiments of the present disclosure. The device 900 can be considered as a further example implementation of the network device 110 or the repeater device 120 or the terminal device 130 as shown in FIG. 1. Accordingly, the device 900 can be implemented at or as at least a part of the network device 110 or the repeater device 120 or the terminal device 130.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a network device comprises a circuitry configured to: determine an application time for a beam of a repeater device: determine a subcarrier spacing associated with the application time: determine time domain resource allocation information indicating the application time based on the determined subcarrier spacing; and transmit, to the repeater device, the time domain resource allocation information and indication information regarding the indicating of the application time.

In some embodiments, a repeater device comprises a circuitry configured to: receive, from a network device, time domain resource allocation information indicating an application time for a beam of a repeater device and indication information regarding the indicating of the application time: determine a subcarrier spacing associated with the application time; and determine the application time based on the time domain resource allocation information, the indication information and the determined subcarrier spacing.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: determining, at a network device, an application time for a beam of a repeater device: determining a subcarrier spacing associated with the application time: determining time domain resource allocation information indicating the application time based on the determined subcarrier spacing; and transmitting, to the repeater device, the time domain resource allocation information and indication information regarding the indicating of the application time.

In some embodiments, the indication information indicates that the application time is associated with a set of consecutive time domain resources. In these embodiments, determining the time domain resource allocation information comprises: determining a slot offset and the number of slots associated with the set of consecutive time domain resources: or determining a slot offset, the number of slots associated with the set of consecutive time domain resources, a symbol offset in the first slot among the slots, and a symbol length in the last slot among the slots.

In some embodiments, determining the time domain resource allocation information further comprises: determining a gap between adjacent time domain resources for the beam and a further beam of the repeater device.

In some embodiments, the indication information indicates that the application time is associated with an indication for turning on or off the repeater device. In these embodiments, determining the time domain resource allocation information comprises: associating, with the indication for turning on or off the repeater device, a valid or invalid resource in a set of consecutive time domain resources; and determining a slot offset and the number of slots associated with the set of consecutive time domain resources.

In some embodiments, the indication information indicates that the application time is associated with a beam index list for a set of beams. In these embodiments, determining the time domain resource allocation information comprises: determining a slot offset, a symbol offset within the first slot for the first beam among the set of beams, the number of symbols for a beam in the set of beams, and the beam index list: determining a slot offset, a symbol offset within the first slot for the first beam among the set of beams, the number of symbols for a beam in the set of beams, the number of guard symbols between adjacent beams among the set of beams, and the beam index list: determining a slot offset, the number of slots for a beam in the set of beams, and the beam index list: or determining a slot offset, the number of slots for a beam in the set of beams, the number of guard slots between adjacent beams among the set of beams, and the beam index list.

In some embodiments, the indication information indicates that the application time is associated with multiple sets of consecutive time domain resources. In these embodiments, determining the time domain resource allocation information comprises: determining a slot offset, the number of slots in one of the multiple sets of consecutive time domain resources, and a gap between adjacent ones of the multiple sets of consecutive time domain resources: or determining a slot offset for the first one of the multiple sets of consecutive time domain resources, the number of slots in one of the multiple sets of consecutive time domain resources, a symbol offset in the first slot for one of the multiple sets of consecutive time domain resources, a symbol length in the last slot for one of the multiple sets of consecutive time domain resources, and a gap between adjacent ones of the multiple sets of consecutive time domain resources.

In some embodiments, the indication information indicates that the application time is associated with a bitmap. In these embodiments, determining the time domain resource allocation information comprises: determining a slot offset, and a bitmap of the application time in time domain resources based on the slot offset.

In some embodiments, the bitmap comprises a first bitmap in a slot level and a second bitmap in a symbol level for a slot, the slot corresponding to a predetermined bit value in the first bitmap.

In some embodiments, a bit length of the bitmap is fixed, or a bit length of the bitmap is configured, or a bit length of the bitmap is associated with the determined sub-carrier spacing.

In some embodiments, a bit length of the bitmap is determined based on a predefined maximum bit length and a bit length when the number of predetermined bit values reaches a first predetermined number.

In some embodiments, the first predetermined number and the predefined maximum bit length are associated with the determined sub-carrier spacing.

In some embodiments, a bit in the bitmap is associated with a slot group. In some embodiments, the number of slots in the slot group is fixed, or the number of slots in the slot group is configured, or the number of slots in the slot group is associated with the determined sub-carrier spacing or a predefined maximum number of slots.

In some embodiments, the slot group corresponds to a predetermined bit value in the bitmap. In these embodiments, determining the time domain resource allocation information further comprises: determining a further bitmap in a slot level for the slot group.

In some embodiments, the number of slot groups associated with the bitmap is fixed, or the number of slot groups associated with the bitmap is configured, or the number of slot groups associated with the bitmap is determined based on a predefined maximum number of slots and the number of slots when the number of slots corresponding to a predetermined bit value reaches a second predetermined number.

In some embodiments, the indication information indicates that the application time is associated with priorities of resources. In these embodiments, determining the time domain resource allocation information comprises: indicating, on a set of consecutive time domain resources comprising a first resource corresponding to the application time and a set of second resources, the application time based on priorities of the first resource and the set of second resources; and determining a slot offset and the number of slots associated with the set of consecutive time domain resources.

In some embodiments, the set of second resources comprises at least one of the following: a semi-static resource; an invalid resource: a reserved resource: a resource for an uplink control channel transmission of the repeater device: or a resource for an uplink data channel transmission of the repeater device.

In some embodiments, determining the subcarrier spacing comprises: determining the subcarrier spacing associated with the application time based on a subcarrier spacing of the repeater device: determining the subcarrier spacing associated with the application time based on a subcarrier spacing of a terminal device, the terminal device communicating with the network device via the repeater device: or determining the subcarrier spacing associated with the application time based on a predetermined or preconfigured subcarrier spacing.

In some embodiments, the slot offset is greater than a threshold, the threshold being associated with processing capability of the repeater device.

In another solution, a method of communication comprises: receiving, at a repeater device and from a network device, time domain resource allocation information indicating an application time for a beam of a repeater device and indication information regarding the indicating of the application time: determining a subcarrier spacing associated with the application time; and determining the application time based on the time domain resource allocation information, the indication information and the determined subcarrier spacing.

In some embodiments, the indication information indicates that the application time is associated with a set of consecutive time domain resources. In these embodiments, determining the application time comprises: determining, from the time domain resource allocation information, a slot offset and the number of slots associated with the set of consecutive time domain resources: or determining, from the time domain resource allocation information, a slot offset, the number of slots associated with the set of consecutive time domain resources, a symbol offset in the first slot among the slots, and a symbol length in the last slot among the slots.

In some embodiments, determining the application time further comprises: determining, from the time domain resource allocation information, a gap between adjacent time domain resources for the beam and a further beam of the repeater device.

In some embodiments, the indication information indicates that the application time is associated with an indication for turning on or off the repeater device. In these embodiments, determining the application time comprises: determining, from the time domain resource allocation information, a slot offset and the number of slots associated with a set of consecutive time domain resources; and determining, based on the indication for turning on or off the repeater device, a valid or invalid resource in the set of consecutive time domain resources.

In some embodiments, the indication information indicates that the application time is associated with a beam index list for a set of beams, and wherein determining the application time comprises: determining, from the time domain resource allocation information, a slot offset, a symbol offset within the first slot for the first beam among the set of beams, the number of symbols for a beam in the set of beams, and the beam index list: determining, from the time domain resource allocation information, a slot offset, a symbol offset within the first slot for the first beam among the set of beams, the number of symbols for a beam in the set of beams, the number of guard symbols between adjacent beams among the set of beams, and the beam index list: determining, from the time domain resource allocation information, a slot offset, the number of slots for a beam in the set of beams, and the beam index list: or determining, from the time domain resource allocation information, a slot offset, the number of slots for a beam in the set of beams, the number of guard slots between adjacent beams among the set of beams, and the beam index list.

In some embodiments, the indication information indicates that the application time is associated with multiple sets of consecutive time domain resources. In these embodiments, determining the application time comprises: determining, from the time domain resource allocation information, a slot offset, the number of slots in one of the multiple sets of consecutive time domain resources, and a gap between adjacent ones of the multiple sets of consecutive time domain resources: or determining, from the time domain resource allocation information, a slot offset for the first one of the multiple sets of consecutive time domain resources, the number of slots in one of the multiple sets of consecutive time domain resources, a symbol offset in the first slot for one of the multiple sets of consecutive time domain resources, a symbol length in the last slot for one of the multiple sets of consecutive time domain resources, and a gap between adjacent ones of the multiple sets of consecutive time domain resources.

In some embodiments, the indication information indicates that the application time is associated with a bitmap. In these embodiments, determining the application time comprises: determining, from the time domain resource allocation information, a slot offset, and a bitmap of the application time in time domain resources based on the slot offset.

In some embodiments, the bitmap comprises a first bitmap in a slot level and a second bitmap in a symbol level for a slot, the slot corresponding to a predetermined bit value in the first bitmap.

In some embodiments, a bit length of the bitmap is fixed, or a bit length of the bitmap is configured, or a bit length of the bitmap is associated with the determined sub-carrier spacing.

In some embodiments, a bit length of the bitmap is determined based on a predefined maximum bit length and a bit length when the number of predetermined bit values reaches a first predetermined number.

In some embodiments, the first predetermined number and the predefined maximum bit length are associated with the determined sub-carrier spacing.

In some embodiments, a bit in the bitmap is associated with a slot group.

In some embodiments, the number of slots in the slot group is fixed, or the number of slots in the slot group is configured, or the number of slots in the slot group is associated with the determined sub-carrier spacing or a predefined maximum number of slots.

In some embodiments, the slot group corresponds to a predetermined bit value in the bitmap. In these embodiments, determining the application time further comprises: determining, from the time domain resource allocation information, a further bitmap in a slot level for the slot group.

In some embodiments, the number of slot groups associated with the bitmap is fixed, or the number of slot groups associated with the bitmap is configured, or the number of slot groups associated with the bitmap is determined based on a predefined maximum number of slots and the number of slots when the number of slots corresponding to a predetermined bit value reaches a second predetermined number.

In some embodiments, the indication information indicates that the application time is associated with priorities of resources. In these embodiments, determining the application time comprises: determining, from the time domain resource allocation information, a slot offset and the number of slots associated with a set of consecutive time domain resources; and determining, based on priorities of a first resource corresponding to the application time and a set of second resources, the application time from the set of consecutive time domain resources.

In some embodiments, the set of second resources comprises at least one of the following: a semi-static resource: an invalid resource: a reserved resource: a resource for an uplink control channel transmission of the repeater device: or a resource for an uplink data channel transmission of the repeater device.

In some embodiments, determining the application time comprises: in accordance with a determination that a priority of a second resource in the set of second resources is higher than a priority of the first resource, determining that time corresponding to the second resource does not belong to the application time; and in accordance with a determination that a priority of the second resource is lower than a priority of the first resource, determining that the time corresponding to the second resource belong to the application time.

In some embodiments, determining the subcarrier spacing comprises: determining the subcarrier spacing associated with the application time based on a subcarrier spacing of the repeater device: determining the subcarrier spacing associated with the application time based on a subcarrier spacing of a terminal device, the terminal device communicating with the network device via the repeater device: or determining the subcarrier spacing associated with the application time based on a predetermined or preconfigured subcarrier spacing.

In some embodiments, the slot offset is greater than a threshold, the threshold being associated with processing capability of the repeater device.

In another solution, a device of communication comprises: a processor configured to cause the device to perform the method according to any of the claims described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a repeater, the method comprising:
receiving, from a network device, a configuration of a set of first time resources used for an access link between the repeater and a terminal device, wherein the configuration of the set of first time resources comprises a priority indication; and
performing communication on the access link based on the priority indication in a case where a first time resource in the set of first time resources overlaps with a second time resource indicated by a control information.

22. The method of claim 21, wherein performing communication on the access link based on the priority indication comprises:
apply the first time resource and a corresponding beam based on the priority indication.

23. The method of claim 21, further comprising:
receiving, from a network device, an indication of a reference subcarrier spacing (SCS) associated with the access link.

24. The method of claim 21, wherein the set of first time resources being a set of semi-static time resources.

25. The method of claim 21, wherein the configuration of the set of first time resources comprises a slot offset, a symbol offset and a duration, wherein the maximum value of the duration is 8 slots.

26. The method of claim 25, wherein the slot offset is greater than a value associated with a capability information of the repeater.

27. The method of claim 21, wherein a time resource used for a control link between the repeater and the network device has priority over a time resource for the access link.

28. A method performed by a terminal device, the method comprising:
performing communication with a repeater on an access link between the repeater and the terminal device, based on a priority indication in a case where a first time resource in a set of first time resources used for the access link overlaps with a second time resource indicated by a control information, wherein a configuration of the set of first time resources is received by the repeater from a network device, wherein the configuration of the set of first time resources comprises the priority indication.

29. The method of claim 28, wherein performing communication on an access link based on a priority indication comprises:
apply the first time resource and a corresponding beam based on the priority indication.

30. The method of claim 28, wherein the set of first time resources being a set of semi-static time resources.

31. The method of claim 28, wherein the configuration of the set of first time resources comprises a slot offset, a symbol offset and a duration, wherein the maximum value of the duration is 8 slots.

32. The method of claim 31, wherein the slot offset is greater than a value associated with a capability information of the repeater.

33. The method of claim 28, wherein a time resource used for a control link between the repeater and the network device has priority over a time resource for the access link.

34. A method performed by a network device, the method comprising:
transmitting, to a repeater, a configuration of a set of first time resources used for an access link between the repeater and a terminal device, wherein the configuration of the set of first time resources comprises a priority indication, wherein the priority indication is used for communication on the access link in a case where a first time resource in the set of first time resources overlaps with a second time resource indicated by a control information.

35. The method of claim 34, wherein the first time resource and a corresponding beam is applied by the repeater based on the priority indication.

36. The method of claim 34, further comprising:
transmitting, to the repeater, an indication of a reference subcarrier spacing (SCS) associated with the access link.

37. The method of claim 34, wherein the set of first time resources being a set of semi-static time resources.

38. The method of claim 34, wherein the configuration of the set of first time resources comprises a slot offset, a symbol offset and a duration, wherein the maximum value of the duration is 8 slots.

39. The method of claim 38, wherein the slot offset is greater than a value associated with a capability information of the repeater.

40. The method of claim 34, wherein a time resource used for a control link between the repeater and the network device has priority over a time resource for the access link.
